(19) United States
(12) Patent Application Publication
(10) Pub. No.: US 2016/0300192 A1
(43) Pub. Date: Oct. 13, 2016

(54) COMMUNICATION DEVICE INTERFACE ALERTS FROM A SERVICE PROVIDER SERVER ON DETECTION OF PRIOR SCHEDULED EVENTS

(71) Applicant: EBAY INC., San Jose, CA (US)

(72) Inventor: Kamal Zamer, Austin, TX (US)

(21) Appl. No.: 14/682,002

(22) Filed: Apr. 8, 2015

(51) Int. Cl. G06Q 10/10; G06Q 30/06

(52) U.S. Cl. CPC G06Q 10/1095; G06Q 30/0633

(57) ABSTRACT

There are provided systems and methods for communication device interface alerts from a service provider server on detection of prior scheduled events. A service provider may provide for purchase request processing to complete a transaction for an item identified in the service request. The item may have a corresponding date for use, redemption, duration, or other time requirement. The service provider may process the time for the item against calendar information for the user that includes events the user may attend, which have previously reserved times associated with attendance to the event. The calendar information may include actual entered events and implied events based on user actions. If any conflicts exist between the item's time and previously reserved times, the user may be alerted of the conflict prior to completing purchase of the item. The user may also be offered with rescheduling and resale services.

### TECHNICAL FIELD

The present application generally relates to prior commitment alerts using interactions between devices in a computer network and more specifically to communication device interface alerts from a service provider server on detection of prior scheduled events.

### BACKGROUND

A user may wish to purchase an item that has a corresponding time or date for use of the item. For example, tickets to a concert are associated with the date and time of the concert so that if the user purchases tickets to a concert, the user has scheduled an upcoming event for attendance by the user. Similarly, purchasable items may be required to be redeemed by a certain date (e.g., a coupon for a tour) or may block off certain dates when the user utilizes the item (e.g., travel, including time spent in another location where the user would not be able to visit another location). However, when viewing the items for purchase, the user may be unaware of prior commitments. Such prior commitments may include specific commitments caused by other scheduling conflicts, including meetings, work, travel, appointments, etc. (e.g., explicit or entered/accepted by the user into a calendar). However, commitments may also include implied commitments caused by the user's daily, weekly, monthly, etc., schedule. For example, an implied commitment may be caused by a requirement to attend a family member's birthday or pick up a medication. Commitments may also be caused by traffic, weather, or other factors unknown to the user. Thus, the user may purchase the item without knowledge that the user may have difficulty in redeeming the item at the corresponding time. At other times, the user may choose to forego purchasing the item knowing a conflict with a prior scheduled event. However, resale of tickets to or cancellation of the prior event may be possible and desirable to the user.

### BRIEF DESCRIPTION OF THE DRAWINGS

FIG. 1 is a block diagram of a networked system suitable for implementing the processes described herein, according to an embodiment;

FIG. 2 is an exemplary device interface on checkout for an item having an associated date where a user purchasing the item may view alerts of conflicting dates, according to an embodiment;

FIG. 3 is an exemplary system environment having a service provider server providing alerts to a user on detection of prior scheduled dates when processing a purchase request for an item, according to an embodiment;

FIG. 4 is a flowchart of an exemplary process for communication device interface alerts from a service provider server on detection of prior scheduled events, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide communication device interface alerts from a service provider server on detection of prior scheduled events using data communicated between devices in a computer network. Systems suitable for practicing methods of the present disclosure are also provided.

A service provider may provide calendar processing services to a user for use with a purchase request by the user for an item to alert the user through a communication device interface of conflicts between a time associated with the item and a previously scheduled event for the user. A server for the service provider may receive a purchase request for the user. The purchase request may include an item that has an associated time or date. An item with an associated time may correspond to a service, event, redeemable coupon, perishable product, or other type of product having a date for use, travel, and/or duration of the item. For example, the item may correspond to a travel ticket, an event at a venue, lodging or vacation reservations, a conference ticket, and/or a purchasable appointment. Thus, when purchasing the event, the user may select a time/date or the time/date for the item may already be set.

However, the user may be unaware of conflicting reserved times for other events that the user has scheduled or that the user is implicitly attending or otherwise scheduled to attend. Thus, a service provider server may provide for calendar processing and alert notification on conflicting schedules by receiving the purchase request established by the user through a checkout interface of a communication device, where the purchase is received from a sales module of the service provider server, a third party merchant server offering the item for sale, and/or a transaction processing module of the service provider server that processes the purchase request to complete a transaction for the item. The service provider may then access calendar information for the user. Calendar information for the user may include a calendar for the user and/or times known to have been reserved for an event for the user. Calendar information may be received from the communication device of the user or from a third party calendaring service, such as a server providing a calendar for use to the user (e.g. GOOGLE®'s calendar). Moreover, the service provider server may determine the calendar information based on received information, scraped online resources (e.g., social networking accounts of a user), and/or user locations, travel routes, payments, and/or other actions.

For example, in determining calendar information for the user, the server for the service provider may receive a calendar having directly entered events that the user has scheduled (e.g., meetings, appointments, travel, etc.). However, calendar information may also be determined where the user has not entered information. A user may have booked a flight but not added travel plans and reserved dates for the flight and associated trip in a calendar. Thus, the service provider may instead receive flight details and enter the associated reserved times for the event into the calendar information. The service provider may receive information on item that the user has purchased, scheduled, and/or received from a payment provider, a third party social networking service, the communication device of the user, or other device/server. For example, other upcoming scheduled events may include a birthday party that the user has replied attending to in a social networking invitation or stated “yes I will attend” in a message to a friend. Thus, the information may include messages by the user (e.g., email, text, instant message) or may include transaction histories for the user, stored event information and admission information for such events, or other available information.

The calendar information may also include implied events that the user is attending or may attend at times based on the user's previous actions. For example, the user may pick up children from school at a certain time every day, may pick up medicine at a certain time every month, may travel to and from work at certain times, or have other types of actions that indicate that the user may attend some event or performs some action at a future time or date. User actions may be determined using location information for the user, such as GPS coordinates or compass directions. The user actions may also be determined from travel routes taken by the user, purchases by the user, motions/movements by the user, biometrics of the user, and/or other information that may indicate user actions.

After receipt and/or determination of the calendar information, the service provider server may access the calendar information on receipt of the purchase request. The service provider may then determine whether a conflict exists between one or more events having corresponding reserved times and the item in the purchase request having an associated time for use, redemption, travel, and/or redemption. If no conflict exists, the service provider may do nothing or may notify the user that no scheduling conflicts exist with the contemplated purchase. However, if a conflict is found to exist with the time of the item in the purchase request and one or more reserved times in the calendar information, an alert may be generated that warns the user of the conflict. The alert may be communicated to the communication device of the user for presentation prior to the user proceeding to have the purchase request processed and completing a transaction for the item. The alert may prevent the user from completing the transaction without acknowledgement of the alert and conflict and/or acceptance of the conflict between the item's time and the calendar information's reserved time. If the user wishes to proceed with the transaction, the user may be required to wait a certain amount of time to read the alert, click a box, enter information, or otherwise acknowledge the alert, or view the conflicting information in a calendar, including the event or events in the calendar having reserved time(s) that conflict with the time of the item.

The service provider may also provide for another time or times that the item is available if the item conflicts with a reserved time for an event in the calendar, where the other time(s) do not conflict with the calendar information. The service provider may also provide for similar items to the item that is available at the other times. The service provider may also determine how important the item to purchase/schedule is and/or how important the event in the calendar information with the reserved time is. The service provider may then generate the alert based on the importance, and may choose not to alert the user if the importance does not rise to a certain prerequisite level. The service provider may also assist the user in rescheduling the previous event having the conflicting reserved time in the calendar information, for example, by messaging participants, planners, or other entities associated with the event and requesting rescheduling. Moreover, if the event has tickets, admission, or other items that may be resold for the event, the service provider may assist the user in resale. In such embodiments, the service provider may determine a cost for resale/rescheduling for the admission so that the user may determine costs associated with both resale and purchase of the item in the purchase request. The service provider may also process the calendar information when receiving a request for entry of a time and event into the calendar and alert both the user and the conflicting party if any conflict exists and the nature of the conflict (e.g., how important the event with the reserved time in the calendar is to the user, how long the conflict is, and whether the conflicting items/events can be reschedule).

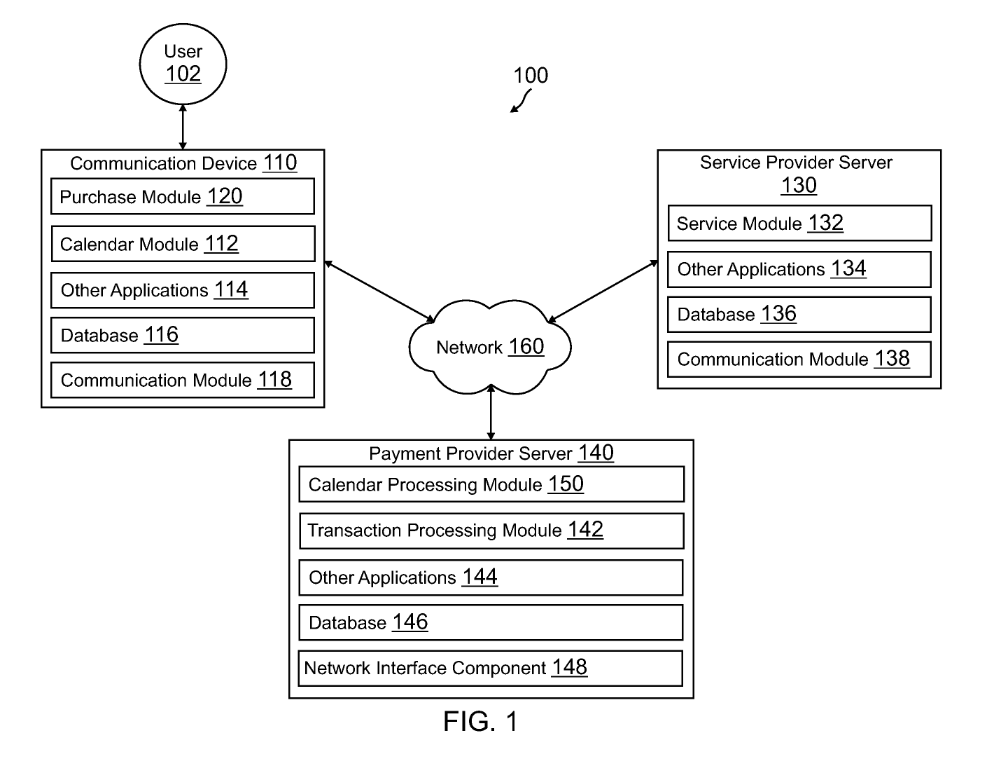

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a service provider server 130, and a payment provider server 140 in communication over a network 160. User 102, such as a purchaser for an item having an associated time (e.g., admission/travel tickets, items with redemption dates, etc.) may submit a purchase request for the item to payment provider server 140, for example, through a merchant selling the item and/or through a website/application for payment provider server 140. Payment provider server 140 may access and/or determine calendar information for user 102, for example, using information available from service provider server 130. Payment provider server 140 may then determine whether any of the events having reserved time(s) in the calendar information conflict with the time for the item in the purchase order. Payment provider server 140 may generate an alert to user 102 through communication device 110 in the event of a conflict, and assist user 102 in different purchases without conflicting times, resale of admission to the conflicting event, and/or rescheduling of the prior events.

Communication device 110, service provider server 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Communication device 110 may be implemented using any appropriate hardware and software configured for wired and/or wireless communication with service provider server 130 and/or payment provider server 140, for example, over network 160. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a purchase module 120, calendar module 112, other applications 114, a database 116, and a communication module 118. Purchase module 120, calendar module 112, and other applications 114 may correspond to executable processes, procedures, and/or applications with associated hardware. In other embodiments, communication device 110 may include additional or different software as required.

Purchase module 120 may correspond to one or more processes to execute modules and associated specialized hardware of communication device 110 to generate or cause to be generated a purchase request for one or more items having one or more times for use, redemption, duration, or other scheduling, review alerts for one or more events in calendar information for user 102 having conflicting reserved time(s), process the purchase request to complete a transaction for the item, and/or perform resale of event admission or rescheduling of the event. In this regard, purchase module 120 may correspond to specialized hardware and/or software utilized to provide a convenient interface to permit user 102 to select payment options and provide payment for items, for example, to a merchant through payment provider server 140. However, in other embodiments, payment provider server 140 may not perform transaction processing, and may instead only assist in determining conflicts between the item's time and calendar information for user 102. Purchase module 120 may be implemented as a user interface enabling user 102 to enter payment options for storage by communication device 110, provide those payment options on checkout/payment of one or more items, and complete a transaction for the item(s) through a purchase request for the item(s). In various embodiments, purchase module 120 may include a general browser application configured to retrieve, present, and communication information over the Internet (e.g., utilize resource on the World Wide Web) or a private network. For example, purchase module 120 may provide a web browser, which may send and receive information over network 160, including retrieving website information, presenting the website information to user 102, and/or communicating information to the website, including payment information. However, in other embodiments, purchase module 120 may include a dedicated application of payment provider server 140 or other entity (e.g., a merchant), which may be configured to assist in processing purchase requests and/or determining conflicting times in calendar information for user 102.

User 102 may browse items for sale that have one or more times for use of the item, for example, through a website of a merchant, an online marketplace (e.g., EBAY® and/or STUBHUB®), or at a physical location, such as a box office, travel agency, etc. User 102 may select an item for purchase and generate, a purchase request for the item using purchase module 120. For example, user 102 may wish to complete a transaction to purchase the item. User 102 may utilize purchase module 120 to generate a purchase request for the item(s) and provide or identify payment information to complete the transaction. Purchase module 120 may utilize user financial information, such as a credit card, bank account, or other financial account, as a payment instrument when providing payment information for use in a purchase request. Additionally, purchase module 120 may utilize a user account with payment provider, such as payment provider server 140, as the payment instrument. The purchase request may be communicated to payment provider server 140 for processing to complete the transaction for the item using the user financial information. In various embodiments, the purchase request may be communicated to a merchant server or device (e.g., as a payment token for the item) over network 160 or may be communicated to payment provider server 140 (e.g., as a payment token including merchant identification for payment to the merchant selling the item). The payment token may also include identification of the item(s) for purchase and a request to purchase the items.

Payment provider server 140 may then access and/or determine calendar information for user 102, for example, using communication device 110 and/or service provider server 130, as explained herein. If an alert is generated of a conflict between the time of the item in the purchase request and one or more reserved times for event(s) in the calendar information for user 102, the alert may be presented to user 102 prior to processing the purchase request through purchase module 120. Purchase module 120 may require user 102 to acknowledge the alert and/or accept receipt of the alert through purchase module 120. Purchase module 120 may prevent user 102 from proceeding with completing the transaction until the conflict is resolved, or may require acknowledge and/or acceptance to proceed with completing the transaction. In various embodiments, purchase module 120 may receive other information, including other times/items available that do not conflict with calendar information, rescheduling information, and/or resale information for admission or other items related to a scheduled event in the calendar information that conflicts with the time of the item.

Purchase module 120 may further be used to proceed with requesting the purchase request to be processed with payment provider server 140. Once the purchase request is processed, purchase module 120 may further display information on completion of the transaction to user 102 or failure to process the purchase request if payment provider server 140 cannot complete the transaction (e.g., bad payment information). Purchase module 120 may further be used to receive, display, and/or store transaction histories documenting completion of the transaction, such as a receipt for the item, as well as item information used for use and/or redemption of the item (e.g., travel ticket information, etc.).

Calendar module 112 may correspond to one or more processes to execute modules and associated specialized hardware of communication device 110 to provide a digital calendar to user 102 having calendar information for user 102 and communicate the calendar information and/or other information used to determine calendar information to payment provider server 140 for processing. In this regard, calendar module 112 may correspond to specialized hardware and/or software utilized to provide a convenient interface to user 102 allowing user 102 to enter, review, edit, and/or delete events in to a digital calendar for communication device 110. Calendar module 112 may therefore receive events having reserved times, such as through user input or from another entity, including a device/server establishing the event (e.g., a person requesting a meeting, a friend extending an invite to an event, etc.). Calendar module 112 may enter the information to a calendar. The information may be communicated to payment provider server 140 by calendar module 112. Calendar module 112 may also enter calendar times and/or dates for items purchased by purchase module 120. In further embodiments, calendar module 112 may also correspond to an application and/or available information for a service provider for use in determining calendar information. For example, calendar module 112 may include social networking, messaging, travel, location, travel path/route, purchase, or other information, which may be processed by payment provider server 140 to determine calendar information, as discussed herein.

In various embodiments, one or more features of purchase module 120 and/or calendar module 112 may be incorporated in the same application so as to provide their respective features in one application.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over a network, or other types of applications. Other applications 114 may also include email, texting, voice and IM applications that allow a user to send and receive emails, calls, texts, and other notifications through a network, including notifications related to social networking, microblogging, and/or media sharing services, which may provide calendar information for calendar module 112 and/or communicate the calendar information to payment provider server 140. In various embodiments, other applications 114 may include financial applications, such as banking, online payments, money transfer, or other applications associated with a payment provider, which may be used to provide purchase and payment information to payment provider server 140 for use in determining calendar information, such as implied events for user 102, as discussed herein. Other applications 114 may include social networking, media sharing, microblogging, and other applications, which may also be used, for example, to provide information to payment provider server 140, which may include identification of accounts and associated account information. Other applications 114 may also provide for tracking of biometrics associated with user 102, as well as locations, which may provide information to payment provider server 140. Other applications 114 may contain software programs, executable by a processor, including a graphical user interface (GUI) configured to provide an interface to the user.

Communication device 110 may further include database 116 which may include, for example, identifiers such as operating system registry entries, cookies associated with purchase module 120, calendar module 112, and/or other applications 114, identifiers associated with hardware of communication device 110, or other appropriate identifiers, such as identifiers used for user/device/account authentication or identification. Identifiers in database 116 may be used by payment provider server 140 to associate communication device 110 with a particular account maintained by payment provider server 140, or by another service provider, such as a social networking service, microblogging service, messaging service, and/or media sharing service. Database 116 may include received and/or communicated information, including calendar information, purchase requests, financial information, and/or alerts.

Communication device 110 includes at least one communication module 118 adapted to communicate with service provider server 130 and/or payment provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 130 may be maintained, for example, by a service provider entity, which may provide services to user 102, which may provide data and/or information to payment provider server 140 to determine calendar information for user 102. In this regard, service provider server 130 includes one or more processing applications which may be configured to interact with communication device 110 and/or payment provider server 140 over network 160 to provide the information to user 102 and/or payment provider server 140. In one example, service provider server 130 may be provided by EBAY®, Inc. of San Jose, Calif., USA, PAYPAL®, Inc. of San Jose, Calif., USA, and/or STUBHUB®, Inc, of San Francisco, Calif., USA. However, in other embodiments, service provider server 130 may be maintained by or include another type of service provider, such as a social networking, messaging, location services, travel, biometric analysis, and/or other type of service provider. Moreover, in other embodiments, service provider server 130 may instead correspond to a device associated with a service and/or entity, including scheduling entities as well as other users performing event scheduling.

Service provider server 130 of FIG. 1 includes a service module 132, other applications 134, a database 136, and a communication module 138. Service module 132 and other applications 134 may correspond to executable processes, procedures, and/or applications with associated hardware. In other embodiments, service provider server 130 may include additional or different modules having specialized hardware and/or software as required.

Service module 132 may correspond to one or more processes to execute modules and associated specialized hardware of service provider server 130 to provide a service to user 102, which may generate data and/or information used to determine calendar information for user 102, and provide such information to payment provider server 140. In this regard, service module 132 may correspond to specialized hardware and/or software to host and/or provide a service to user 102, which may include or be associated with calendaring (e.g., scheduling of events and/or reserving of user 102's time and dates), social networking, messaging, mapping and travel routing, location, biometrics, payment/purchase, and other types of services. Thus, service module 132 may host a website offering the aforementioned services or provide such services through a dedicated application available for use with a communication device (e.g., an email server accessible through a website/application, a social networking server, etc.). Service module 132 may facilitate the generation of data/information used to determine calendar information by generating the data/information related to events having associated times/dates reserved for attendance by user 102. For example, service module 132 may set an event through received input from user 102 or another entity. In other embodiments, the information may include exchanged messages or invitations sent through a social networking service. Service module 132 may also provide actions and/or interactions by user 102 using services, which may be used to determine whether user will or will not attend an event. A map, location, and/or travel route by user 102 may be used to determine implied events by a user, such as work time, required appointments, etc. Service module 132 may also provide biometrics used to determine when a person is awake, asleep, exercising, or performing another activity that may correspond to an event having a future reserved time. For example, biometrics may be used to determine when user 102 is exercising, when user 102 sleeps, when user 102 eat, or other information about user 102 for use in determining implied events in the calendar information. Service module 132 may also provide payment/purchase information, which may be used to determine calendar information, such as future required purchases and/or locations for purchase, as well as event for which user 102 has purchased admission or other item indicating attendance to the event.

In various embodiments, service provider server 130 includes other applications 134 as may be desired in particular embodiments to provide features to service provider server 130. For example, other applications 134 may include security applications for implementing server-side security features, programmatic client applications for interfacing with appropriate application programming interfaces (APIs) over network 160, or other types of applications. Other applications 134 may contain software programs, executable by a processor, including a graphical user interface (GUI), configured to provide an interface to user 102 when accessing service provider server 130. In various embodiments where not provided by service module 132, other applications 134 may include connection and/or communication applications, which may be utilized to communicate information to over network 160.

Additionally, service provider server 130 includes database 136. Database 136 may be utilized to store information utilized by one or more modules and/or applications of service provider server 130, including service module 132 and/or other applications 134. In this regard, database 136 may include received and/or determined information, including identifiers and other identification information. Information and data generated using service provider server 130 by user 102 and for use in determining calendar information by payment provider server 140 may also be stored to database 136 and/or communicated to payment provider server 140.

In various embodiments, service provider server 130 includes at least one communication module 138 adapted to communicate communication device 110 and/or payment provider server 140 over network 160. In various embodiments, communication module 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 140 may be maintained, for example, by an online payment service provider, which may provide payment services and/or processing for financial transactions on behalf of users, including processing of received purchase requests for a transaction. In this regard, payment provider server 140 includes one or more processing applications which may be configured to interact with communication device 110 and/or service provider server 130 to facilitate payment for a transaction to purchase an item, including alerting user 102 if a time/date for the item conflicts with an existing event having a reserved time/date in calendar information. In one example, payment provider server 140 may be provided by PAYPAL®, Inc. of San Jose, Calif., USA. However, in other embodiments, payment provider server 140 may be maintained by or include a credit provider, financial services provider, financial data provider, calendaring services, planning services, and/or other service provider, which may provide payment services and/or calendaring services (e.g., determination of conflicting events) to user 102.

Payment provider server 140 of FIG. 1 includes a calendar processing module 150, a transaction processing module 142, other applications 144, a database 146, and a communication module 148. Calendar processing module 150, transaction processing module 142, and other applications 144 may correspond to executable processes, procedures, and/or applications with associated hardware. In other embodiments, payment provider server 140 may include additional or different modules having specialized hardware and/or software as required.

Calendar processing module 150 may correspond to one or more processes to execute modules and associated specialized hardware of payment provider server 140 to access and/or determine calendar information for user 102 and process the calendar information using a purchase request for an item having an associated time for use of the item to determine any conflicts between the item's time and one or more events' reserved times in the calendar information. In this regard, calendar processing module 150 may correspond to specialized hardware and/or software to access a purchase request for user 102 received over network 160, for example, from communication device 110 and/or from a merchant selling the item to user 102. Calendar processing module 150 may identify user 102 from the purchase request, such as through personal information, an identifier, or other identification information received with the purchase request. Once user 102 is identified, calendar processing module 150 may be used to determine if the time for the item in the purchase request conflicts with any events in the calendar information. Thus, calendar processing module 150 may then access and/or determine calendar information for user 102.

Calendar processing module 150 may access calendar information from a previously established calendar that includes the events, obligations, responsibilities, and other reserved times and/or dates. The calendar may be stored to calendar module 112 and communicated to payment provider server 140, stored with another entity including service provider server 130 where service provider server 130 provides calendaring services to user 102, and/or stored to database 146. However, in other embodiments, calendar processing module 150 may be required to determine the calendar information. In such embodiments, calendar processing module 150 may receive data and/or information for user in determining events having reserved times for user 102. In other embodiments, calendar processing module 150 may scrape available online resources, such as social networking, microblogging, and/or media sharing resources to receive the information.

For example, the calendar information may include obvious, required, or explicitly entered events, which may include events entered to the calendar and/or calendar information, for example, by user 102 and/or by another person/entity associated with user 102 (e.g., friend, secretary, etc.). In various embodiments, however, the event may not be entered to the calendar but be apparent from received information. Calendar processing module 150 may receive information for travel and/or lodging plans by user 102, such as flight and/or hotel reservations obtained from purchase histories, emails, and other suitable sources. Calendar processing module 150 may enter the information as an event having reserved times/dates into the calendar information. Calendar processing module 150 may also receive information of other purchased, scheduled, and/or accepted events from communication device 110, service provider server 130, and/or another entity. The information may include an event accepted on a social networking platform or through messages through such a platform, messaging service, and/or microblog, for example, a birthday party. Such acceptance may include an “I accept” RSVP to an invitation, or may include a message to the event planner or other person/entity associated with the event accepting the event. However, if user 102 has not responded to the event, calendar processing module 150 may infer attendance by user 102 based on user 102's comments, posts, or other actions, including viewing of the invitation. Calendar processing module 150 may also process such actions based on user 102's past actions and/or relationship to the event to determine whether user 102 will attend. For example, if user 102 rarely responds but attends the events (determined based on location information, later messages, media of the user at the event including pictures and video, etc.), or where user 102 is related to or closely associated with (based on processed information) the event or the event's planner, then calendar processing module 150 may determine that user 102 is likely attending the event. Moreover, a transaction history, stored event information, admission information, or other available information may also be used to determine the obvious/apparent events that are established through direct information of an event.

Calendar processing module 150 may also determine implied events having time and dates for user 102 based on received information. Location information, travel and/or mapping information, biometrics, purchases, compass directions, and/or related user schedules may all be used to determine implied events. An implied event may be an event user 102 may attend based on past actions by user 102, and may be recurring. For example, an implied event may be a time to pick up user 102's medication, children from school or care services, visit a location, purchase some item (e.g., coffee in the morning, lunch in the afternoon, etc.), or other type of recurring action by user 102. In this regard, based on where user 102 is located at certain times during the day, purchases, types of purchases, and/or location of purchases, biometrics of the user, or other information, implied events that user 102 may attend may be determined (e.g., when a user drives to work, exercises, picks up children from school, etc.). The implied event may be entered to the calendar information by calendar processing module 150 based on the recurrence rate and/or type of implied event.

Once the calendar information is accessed and/or determined by calendar processing module 150, calendar processing module 150 may then analyze the time in the purchase request with the calendar information to determine whether the time conflicts with any reserved time for items in the calendar information. If no conflict exists, calendar processing module 150 may allow for the purchase order to be processed by transaction processing module 142, as explained herein. However, if a conflict exists, an alert may be generated and communicated to communication device 110 for viewing before processing the purchase request to complete a transaction for the item in the purchase request. As discussed herein, purchase module 120 may require some form of viewing, acknowledgement, and/or acceptance of the alert prior to proceeding with processing the purchase request. If user 102 reschedules the conflicting event in the calendar information and/or accepts receipt of the alert, calendar processing module 150 may then proceed with processing the purchase request using transaction processing module 142.

In various embodiments, calendar processing module 150 may propose a new time for the same item in the alert that does not conflict with the calendar information, or may propose a similar item at a new time in the alert. Thus, user 102 may generate a new purchase request at a time that does not conflict with the calendar information. In further embodiments, calendar processing module 150 may allow for rescheduling of the conflicting event in the calendar information, for example, by communicating with an entity associated with the event (e.g., an administrator, host, meeting attendee, etc.) and rescheduling the event. Where the event has associated admission, calendar processing module 150 may determine resale potential, cost, and amount for resale of the admission, which may be communicated to user 102 for determination of whether user 102 would like to resell the tickets (e.g., if the admission cost more than the item and user 102 would receive a net profit). Such information may be determined from a merchant or online marketplace. Calendar processing module 150 may assist in posting of a resale advertisement or offer in the event that user 102 accepts resale. Moreover, in various embodiments, calendar processing module 150 may determine how important the event with the reserved time in the calendar is to the user, how long the conflict is, and whether the conflicting items/events can be reschedule, which may be used to determine the alert to user 102. Thus, where conflicts are of low priority, the alert may be skipped or may not be required to be resolved prior to processing the purchase request.

Transaction processing module 142 may correspond to one or more processes to execute modules and associated specialized hardware of payment provider server 140 to receive a purchase request for an item having an associated time/date for use and process the purchase request to complete a transaction for the item using payment information for user 102. In this regard, transaction processing module 142 may correspond to specialized hardware and/or software to receive a purchase request, for example, for communication device 110 and/or from a merchant device/server associated with a merchant selling the item to user 102. The purchase request may identify the item and/or the associated time/date, as well as a payment instrument and identification of the transaction, in various embodiments. The purchase request may be processed by calendar processing module 150 prior to completion of the transaction, as discussed herein. Transaction processing module 142 may then receive authorization to proceed with processing the purchase request from user 102 in the event of no conflict or of acceptance/resolution of the conflict.

Once authorized to proceed is received, transaction processing module 142 may utilize a payment account or financial information (e.g., a payment instrument such as a credit/debit card, bank account, etc.) of user 102 to render payment for the item and complete the transaction. Payment may be made to a merchant device/service using the payment instrument and the terms of the purchase request. In various embodiments, payment may instead be made to a merchant account service by payment provider server 140. Additionally, transaction processing module 142 may provide transaction histories, including receipts, to user 102 through communication device 110 and/or the merchant through the merchant device/server for completion and documentation of the financial transaction. Such transaction histories may be utilized to determine and/or update calendar information, in further embodiments.

In various embodiments, payment provider server 140 includes other applications 134 as may be desired in particular embodiments to provide features to payment provider server 140. For example, other applications 134 may include security applications for implementing server-side security features, programmatic client applications for interfacing with appropriate application programming interfaces (APIs) over network 160, or other types of applications. Other applications 134 may contain software programs, executable by a processor, including a graphical user interface (GUI), configured to provide an interface to user 102 when accessing payment provider server 140, such as a website interface and/or information for an application interface. In various embodiments where not provided by calendar processing module 150, other applications 134 may include connection and/or communication applications, which may be utilized to communication information to over network 160.

Additionally, payment provider server 140 includes database 146. Database 136 may be utilized to store information utilized by one or more modules and/or applications of payment provider server 140, including calendar processing module 150, transaction processing module 142, and/or other applications 134. In this regard, database 146 may include received and/or determined information, including information used to determine calendar information, the calendar information, purchase requests, and/or alerts for conflicting times and/or dates.

In various embodiments, payment provider server 140 includes at least one communication module 138 adapted to communicate communication device 110 and/or service provider server 130 over network 160. In various embodiments, communication module 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

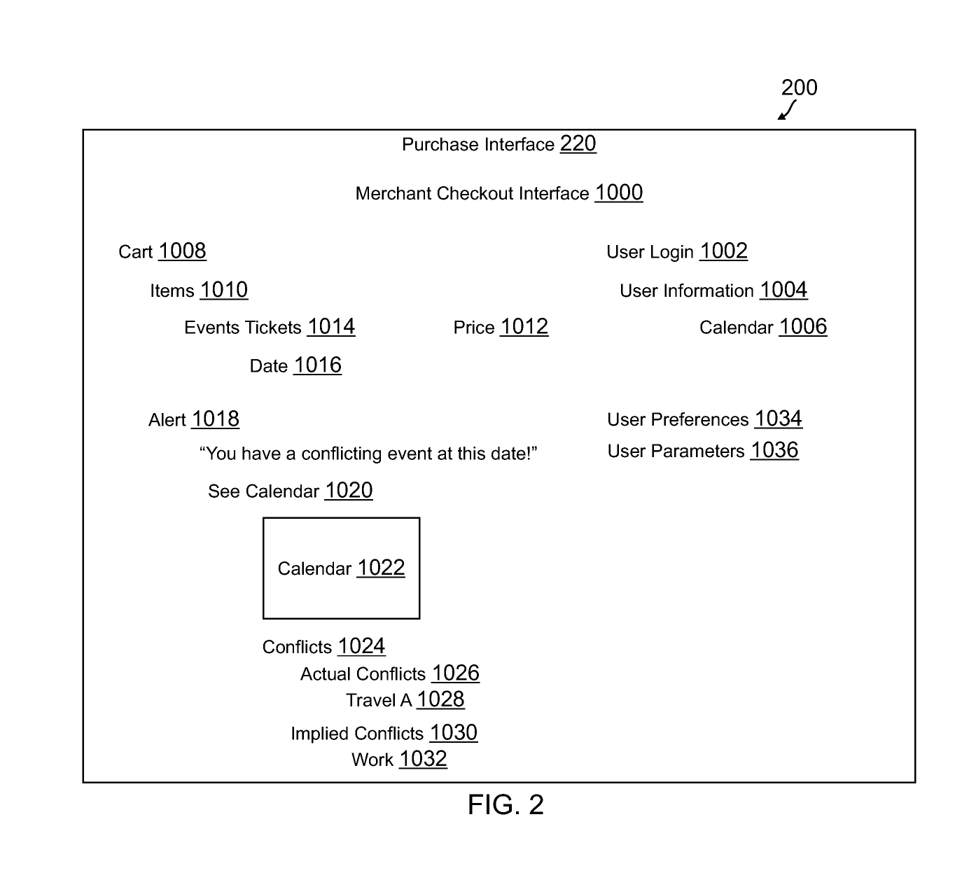

FIG. 2 is an exemplary device interface on checkout for an item having an associated date where a user purchasing the item may view alerts of conflicting dates, according to an embodiment. Environment 200 of FIG. 2 includes a purchase interface 220 corresponding generally to a displayable interface of purchase module 120 on communication device 110.

In environment 200, purchase interface 220 displays a merchant checkout interface 1000, which may be displayed to a user, such as user 102, on checkout for an item having a time for use of the item. Merchant checkout interface 1000 may be displayed from a merchant website/application or may be displayed from a payment provider website/application. Merchant checkout interface 1000 includes information that may be displayed during processing of a purchase request for an item and alerting the user of any potential conflicts between the time for use of the item and calendar information, such as reserved time(s) for events. Thus, merchant checkout interface 1000 includes user login 1002, which may include user information 1004 for the user utilizing purchase interface 220, for example, a calendar 1006. Calendar 1006 may be used to view events of the user, as well as reserved times for such events.

Merchant checkout interface 1000 further includes a cart 1008, which may include items 1010 for the user. Items 1010 may include events 1014, which may have a price 1012 as well as a date 1016 for use of event tickets 1014. Date 1016 may be checked against reserved times in calendar information for the user, such as calendar 1006. If a conflict exists between a reserved time and date 1016, alert 1018 may populate. For example, alert 1018 includes a comment, “You have a conflicting event at this date!” Moreover, alert 1018 includes calendar 1020, which may correspond to a selectable option to populate calendar 1022, which may display the conflicting times. Conflicts 1024 may also display the conflicting times, which may include actual conflicts 1026 such as travel A 1028 (e.g., plane tickets, hotel reservations, etc.). Conflicts 1024 may also include implied conflicts 1030, which includes work 1032 determined based on actions of the user. Merchant checkout interface 1000 includes options to set user preferences 1034 and/or user parameters 1036, which may be used to determine calendar information and/or scheduling, rescheduling, and/or resale of events and event admission.

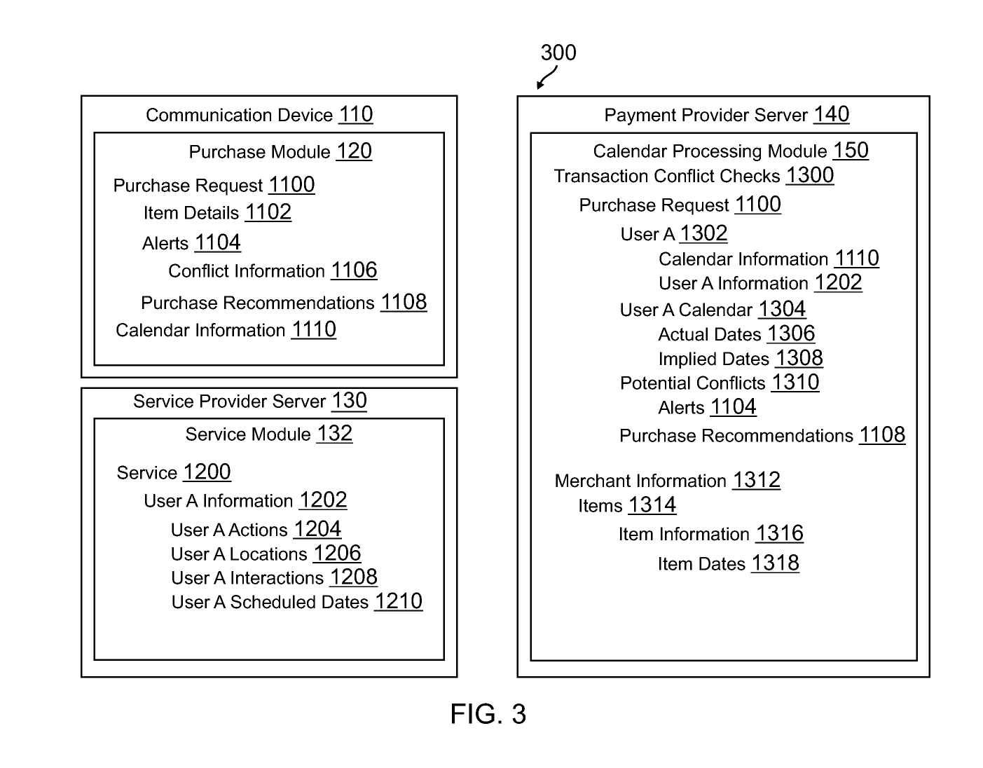

FIG. 3 is an exemplary system environment having a service provider server providing alerts to a user on detection of prior scheduled dates when processing a purchase request for an item, according to an embodiment. Environment 300 includes communication device 110, service provider server 130, and payment provider server 140 of FIG. 1. The below described hardware and/or software modules execute functions as described herein with respect to environment 100.

Communication device 110 executes purchase module 120 having specialized hardware and/or software modules and processes described herein in reference to FIG. 1. In this regard, purchase module 120 includes a purchase request 1100 for an item having a time for use of the item. Thus, purchase request 1100 includes item details 1102. Purchase module 120 may further include information for alerts 1104 based on item devices 1102 and calendar information 1110 accessed/determined by payment provider server 140. In various embodiments, calendar information 1110 may include information from service provider server 130 and/or other entities as determined by calendar processing module 150. Alerts 1104 may include conflict information 1106 for display to a user using purchase module 120. Moreover, purchase recommendations 1108 may be received and presented to the user through purchase module 120.

Payment provider server 140 executes calendar processing module 150 having specialized hardware and/or software modules and processes described herein in reference to FIG. 1. Calendar processing module 150 may be utilized to determine calendar information and process purchase requests to determine conflicts. Thus, calendar processing module 150 includes transaction conflict checks 1300, which may include a purchase request 1100 for processing. Purchase request 1100 may include information for a use A 1302 submitting the purchase request, which may be utilized to access and/or determine calendar information 1110 as well as user A information 1202 (e.g., for determination of calendar information 1110). Calendar processing module 150 may further determine user A calendar 1304, which may include actual dates 1306 of required or explicitly entered events and implied dates 1308 for events implied that user A 1302 may attend. Using the aforementioned information, potential conflicts 1310 may be determined by calendar processing module 150, which may lead to alerts 1104 transmitted to communication device 110 over a network. Moreover, in order to provide other options to the user in the event of conflicts 1310, purchase recommendations 1108 may be determined. Purchase recommendations 1108 may be determined using merchant information 1312 available from a merchant selling the item in purchase request 1100, for example, items 1314 having item information 1316, such as item dates 1318.

Service provider server 130 executes service module 132 having specialized hardware and/or software modules and processes described herein in reference to FIG. 1. In this regard, service module 132 includes information that may be used to determine calendar information 1110 of calendar processing module 150. Thus, service module 132 includes a service 1200 offered to user A 1302, which may correspond to social networking, payment, messaging, location/mapping, biometrics, etc. Service 1200 includes user A information A 1202 used to determine calendar information 1110, which may include user A actions 1204, user A locations 1206, user A interactions 1208, and/or user A scheduled dates 1210. All of the aforementioned information may be communicated to calendar processing module 150 for determination of calendar information 1110.

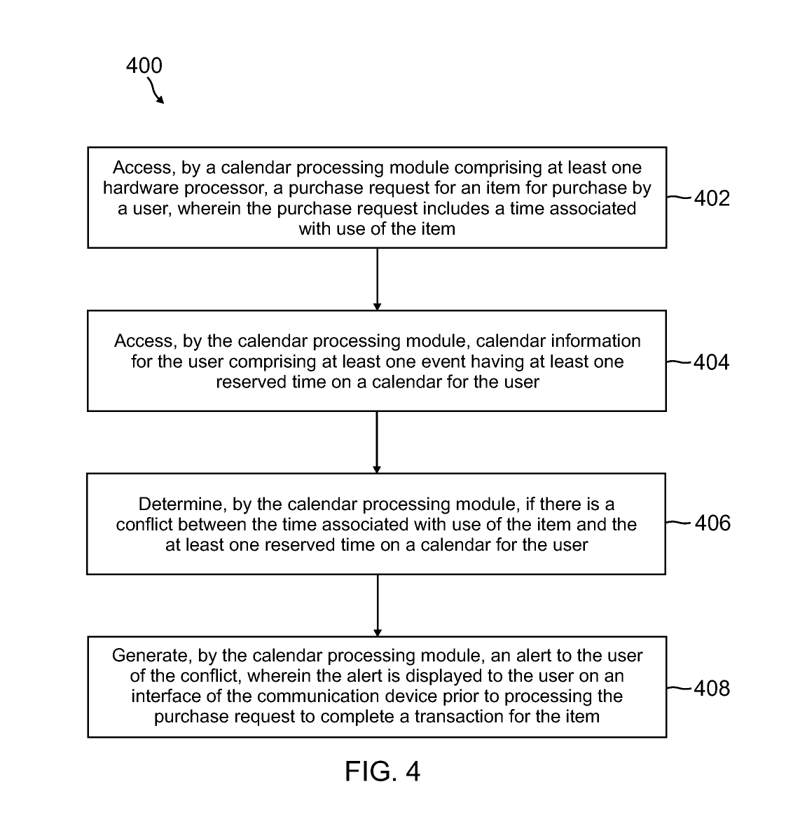

FIG. 4 is a flowchart of an exemplary process for communication device interface alerts from a service provider server on detection of prior scheduled events, according to an embodiment. Note that one or more steps, processes, and methods described herein may be omitted, performed in a different sequence, or combined as desired or appropriate.

At step 402, a purchase request for an item for purchase by a user is accessed, by a calendar processing module comprising at least one hardware processor, wherein the purchase request includes a time associated with use of the item. The purchase request may be received from a third party merchant that offers for sale the item. The item may comprise one of a travel ticket, an event at venue, a lodging or vacation reservation, a conference ticket, and a purchasable appointment, wherein the time comprises a time period or a date period associated with at least one of use, travel, and duration of the item. The purchase request may include any indication that the user may be interested in a purchase and is not limited to submitting a purchase request. For example, a purchase request may include a search for a particular event held at a specific time, date, and place or a more generalized search for events being held at a specific time, date, and/or place. The purchase request may also include an item being placed into a shopping cart or added to a wish list. In this way, a user may be alerted to a possible scheduling conflict before the user spends too much time determining whether to purchase an item (e.g., an event ticket) of interest.

Calendar information for the user comprising at least one event having at least one reserved time on a calendar for the user is accessed, by the calendar processing module, at step 404. The calendar information may comprise a calendar of the user having the at least one event, wherein the calendar processing module determines the calendar using at least one of the communication device, the database, and a third party service provider. For example, the at least one event in calendar may comprise at least one of a specific event entered by user or another user into the calendar and an implicit event determined based on prior actions by the user.

At step 406, the calendar processing module determines if there is a conflict between the time associated with use of the item and the at least one reserved time on a calendar for the user. The calendar processing module may further determine an arrival amount of time to travel to the at least one event having the conflict with the time and a departure amount of time to leave the at least one event and arrive at another event associated with the item, wherein the arrival amount of time and the departure amount of time is added to the at least one reserved time when determining if there is the conflict. The travel time may factor in traffic, weather, mode of transportation, etc. that may vary from event to event. Thus, time associated with getting to and/or from an event (associated with both the desired event and the already scheduled event) may enable a more accurate determination of a scheduling conflict. An alert to the user of the conflict is generated, by the calendar processing module, if there is a conflict between the time and the at least one reserved time, at step 408. The alert may be communicated to a communication device of the user by a network interface component, wherein the alert is displayed to the user on an interface of the communication device prior to processing the purchase request to complete a transaction for the item. The interface of the communication device may present the alert during a checkout process for the purchase request on the interface, wherein the communication device prevents purchase until acknowledgment of the alert by the user.

In various embodiments, the calendar processing module further determines a second time for the first item or the second time of a second item associated with the first item, wherein the second time does not conflict with the at least one reserved time, and wherein the network interface component further communicates the second time or the second item to the communication device. The calendar processing module may also further determine a first cost for the first item and a second cost for resale of a second item associated with the at least one event, wherein the network interface component communicates the first cost and the second cost to the communication device for display in the interface. The calendar processing module may generate an offer to resell the second item if the buyer completes the transaction for the first item, wherein the network interface component communicates the offer to the communication device for display in the interface. The calendar processing module may receive an acceptance of the offer to resell the second item, wherein the calendar processing module performs a rescheduling of the at least one event with other users attending the at least one event.

A transaction processing module comprising at least one hardware processor may receive the purchase request initiated by the user using the communication device with a merchant server for a merchant offering the item for sale. The transaction processing module may further receive a request to process the purchase request to complete the transaction for the item from user input to the interface of the communication device and process the purchase request to provide a payment for an amount of the transaction to the merchant, wherein the user input confirms that the user viewed the alert in the interface of the communication device. A transaction history comprising an authorization of the purchase request and completion of the transaction for the item may be received, where the calendar processing module updates the calendar information to overwrite the at least one reserved time with the time. An entity associated with the at least one event having the at least one reserved time and the conflict may be notified, for example, of the update. Moreover, an update for a calendar module of the communication device may be generated, wherein the update sets the time in a calendar application interface of the calendar module. A purchase module of the communication device may comprise the interface displaying the alert, and may output the interface using at least one output device of the communication module, wherein the interface displays an interactive calendar to the user showing the conflict, the time, and the at least one reserved time, and wherein the user provides input to the interactive calendar to view item information for the item and event information for the at least one event.

In various embodiments, the calendar processing module may further determine a specific event importance of the specific event based on at least one of a social interaction on a third party social networking service server, a family requirement entered to the calendar, a work requirement entered to the calendar or determined from a work server associated with the user, wherein the calendar processing module further determines an implicit event importance of the implicit events based on the prior actions by the user and implicit event information associated with a type of the implicit event, and wherein the calendar processing module further generates the alert using the specific event importance and the implicit event importance levels. For example, the specific event importance may be associated with an explicit requirement to attend the specific event, such as a work meeting, a family requirement, an appointment with a care provider or other type of assistant, or other information that dictates how important it is to attend the specific event. Similarly, the implicit event importance may dictate how important it is for the user to attend or complete the implicit event, such as a requirement to pick up children from a location (school, practice, etc.), when the user wishes to or should work out, or other type of information indicating that the user is required to or should attend the implicit event. Using such information the alert may be generated if a conflict exists between an event a user has to attend, or may not be generated if the user is not required to or it is not important that the user attends an event. The user may set an importance threshold, value, or requirement for which the calendar processing module uses to determine whether to generate an alert based on the importance level of the events.

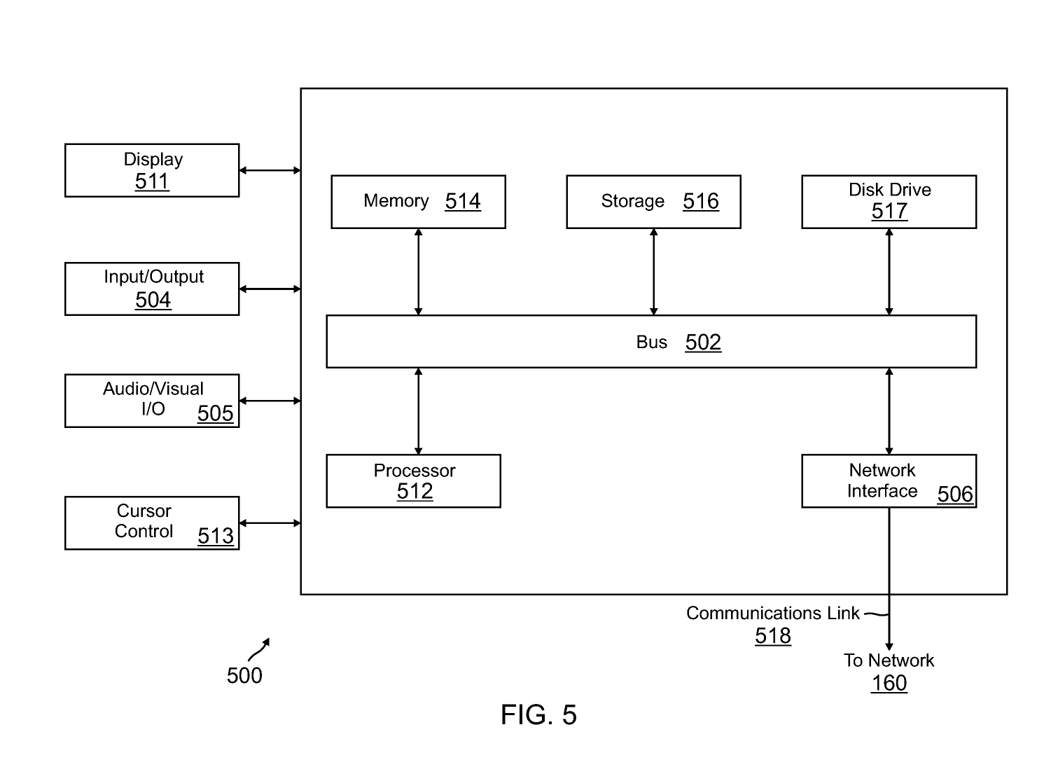

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via a network. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a calendar processing module comprising at least one hardware processor that accesses a purchase request for a first item for purchase by a user, wherein the purchase request includes a first time associated with the first item, accesses calendar information for the user comprising at least one event having at least one reserved time on a calendar for the user, determines if there is a conflict between the first time associated with use of the first item and the at least one reserved time on a calendar for the user, and generates an alert to the user of the conflict if there is a conflict between the time and the at least one reserved time;
a database stored to a non-transitory memory that stores the purchase request, the calendar information, the conflict, and the alert; and
a network interface component that receives the purchase request and communicates the alert to a communication device of the user, wherein the alert is displayed to the user on an interface of the communication device prior to processing the purchase request to complete a transaction for the first item.

2. The system of claim 1, further comprising:
a transaction processing module comprising at least one hardware processor that receives the purchase request initiated by the user using the communication device with a merchant server for a merchant offering the first item for sale, receives a request to process the purchase request to complete the transaction for the first item from user input to the interface of the communication device, and processes the purchase request to provide a payment for an amount of the transaction to the merchant, wherein the user input confirms that the user viewed the alert in the interface of the communication device.

3. The system of claim 1, wherein the purchase request is received from a third party merchant that offers for sale the item.

4. The system of claim 1, wherein the first item comprises one of a travel ticket, an event at a venue, a lodging or vacation reservation, a conference ticket, and a purchasable appointment, and wherein the first time comprises a time period or a date period associated with at least one of use, travel, and duration of the first item.

5. The system of claim 1, wherein the calendar information comprises a calendar of the user having the at least one event, and wherein the calendar processing module determines the calendar using at least one of the communication device, the database, and a third party service provider.

6. The system of claim 5, wherein the at least one event in calendar comprises at least one of a specific event entered by user or another user into the calendar and an implicit event determined based on prior actions by the user.

7. The system of claim 6, wherein the calendar processing module further determines a specific event importance of the specific event based on at least one of a social interaction on a third party social networking service server, a family requirement entered to the calendar, a work requirement entered to the calendar or determined from a work server associated with the user, wherein the calendar processing module further determines an implicit event importance of the implicit events based on the prior actions by the user and implicit event information associated with a type of the implicit event, and wherein the calendar processing module further generates the alert using the specific event importance and the implicit event importance.

8. The system of claim 1, wherein the calendar processing module further determines an arrival amount of time to travel to the at least one event having the conflict with the time and a departure amount of time to leave the at least one event and arrive at another event associated with the item, and wherein the arrival amount of time and the departure amount of time is added to the at least one reserved time when determining if there is the conflict.

9. The system of claim 1, wherein the calendar processing module further processes a current location for the user, a distance to travel to an item event associated with the item, and a travel time to travel to the item event and determines if the user is able to attend the item event using the current location, the distance, and the travel time, wherein the calendar processing module further generates the alert based on if the user is able to attend the item event.

10. The system of claim 1, wherein the interface of the communication device presents the alert during a checkout process for the purchase request on the interface, and wherein the communication device prevents purchase until acknowledgment of the alert by the user.

11. The system of claim 1, wherein the calendar processing module further determines a second time for the first item or the second time of a second item associated with the first item, wherein the second time does not conflict with the at least one reserved time, and wherein the network interface component further communicates the second time or the second item to the communication device.

12. The system of claim 1, wherein the calendar processing module further determines a first cost for the first item and a second cost for resale of a second item associated with the at least one event, and wherein the network interface component communicates the first cost and the second cost to the communication device for display in the interface.

13. The system of claim 12, wherein the calendar processing module generates an offer to resell the second item if the user completes the transaction for the first item, and wherein the network interface component communicates the offer to the communication device for display in the interface.

14. The system of claim 13, wherein the calendar processing module receives an acceptance of the offer to resell the second item, and wherein the calendar processing module performs a rescheduling of the at least one event with other users attending the at least one event.

15. A method comprising:
accessing, by a calendar processing module comprising at least one hardware processor, a purchase request for an item for purchase by a user, wherein the purchase request includes a time associated with use of the item;
accessing, by the calendar processing module, calendar information for the user comprising at least one event having at least one reserved time on a calendar for the user;
determining, by the calendar processing module, if there is a conflict between the time associated with use of the item and the at least one reserved time on a calendar for the user;
generating, by the calendar processing module, an alert to the user of the conflict if there is a conflict between the time and the at least one reserved time; and
communicating, by a network interface component, the alert to a communication device of the user, wherein the alert is displayed to the user on an interface of the communication device prior to processing the purchase request to complete a transaction for the item.

16. The method of claim 15, further comprising:
receiving, by the network interface component, a transaction history comprising an authorization of the purchase request and completion of the transaction for the item; and
updating, by the calendar processing module, the calendar information to overwrite the at least one reserved time with the time.

17. The method of claim 16, further comprising:
notifying, by the calendar processing module, an entity associated with the at least one event having the at least one reserved time of the time and the conflict.

18. The method of claim 16, further comprising:
generating, by the calendar processing module, an update for a calendar module of the communication device, wherein the update sets the time in a calendar application interface of the calendar module.

19. The method of claim 15, wherein a purchase module of the communication device comprises the interface and outputs the interface using at least one output device of the communication module, wherein the interface displays an interactive calendar to the user showing the conflict, the time, and the at least one reserved time, and wherein the user provides input to the interactive calendar to view item information for the item and event information for the at least one event.

20. A non-transitory computer-readable medium comprising executable modules which, in response to execution by a computer system, cause the computer system to perform a method comprising:
accessing, by a calendar processing module comprising at least one hardware processor, a purchase request for an item for purchase by a user, wherein the purchase request includes a time associated with use of the item;
accessing, by the calendar processing module, calendar information for the user comprising at least one event having at least one reserved time on a calendar for the user;
determining, by the calendar processing module, if there is a conflict between the time associated with use of the item and the at least one reserved time on a calendar for the user;
generating, by the calendar processing module, an alert to the user of the conflict if there is a conflict between the time and the at least one reserved time; and
communicating, by a network interface component, the alert to a communication device of the user, wherein the alert is displayed to the user on an interface of the communication device prior to processing the purchase request to complete a transaction for the item.
